(19) United States
(12) Patent Application Publication
(10) Pub. No.: US 2003/0236968 A1
(43) Pub. Date: Dec. 25, 2003

(54) Method and apparatus for generating efficient data structures for use in pipelined forwarding engines

(76) Inventors: Anindya Basu, Jersey City, NJ (US); Girija J. Narlikar, Jersey City, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/175,461

(22) Filed: Jun. 19, 2002

(51) Int. Cl. G06F 7/38

(52) U.S. Cl. 712/225

(57) ABSTRACT

A method and apparatus for generating a routing trie data structure for use in a pipelined forwarding engine such that potions of the trie may be advantageously allocated among the memories associated with the various pipeline stages. In accordance with one illustrative embodiment of the present invention, a dynamic programming technique is advantageously employed to build a trie which may be allocated to a plurality of pipeline stages such that the maximum memory allocated to a stage is minimized (thereby ensuring that the memory is relatively balanced across all pipeline stages). The trie which is built in accordance with this illustrative embodiment of the present invention is advantageously a fixed-stride trie containing exactly one trie level in the memory of each pipeline stage.

### FIELD OF THE INVENTION

The present invention relates generally to the field of packet-based data networks and more particularly to a method and apparatus for generating routing trie data structures which support efficient incremental updates when used in IP (Internet Protocol) router forwarding engines employing pipelined ASIC (Application Specific Integrated Circuit) architectures.

### BACKGROUND OF THE INVENTION

Recent advances in optical networking technology have pushed line card data transfer rates in high speed IP routers to 40 Gbits/s (gigabits per second), and even higher data rates are expected in the near term. Given such high data rates, packet forwarding in high speed IP routers must necessarily be done in hardware. Current hardware-based solutions for high speed packet forwarding fall into two main categories, namely, ASIC-based solutions and ternary CAM (Content-Addressable Memory) or TCAM-based solutions. (Network processor-based solutions are also being considered for high speed packet forwarding, although network processors that can handle 40 Gbits/s wire speeds are not yet generally available.)

ASIC-based architectures typically implement a data structure known as a “routing trie” using some sort of high speed memory such as SRAMs. As is well known to those skilled in the art, a routing trie is a tree-based data structure used to store routing prefixes for use in longest prefix matching. If a single SRAM memory block is used to store the entire routing trie, multiple accesses (one per routing trie level) are required to forward a single packet. This can slow down lookups considerably, and the forwarding engine may not be able to process incoming packets at the line rate. Recently, however, it has been proposed that forwarding speeds can be significantly increased if pipelining is used in ASIC-based forwarding engines. This is because with multiple stages in the pipeline (e.g., one stage per trie level), one packet can be forwarded during every memory access time period.

In addition, pipelined ASICs that implement routing tries provide a general and flexible architecture for a wide variety of forwarding and classification tasks. This is a major advantage in today's high end routers which have to provide packet flow classification and filtering, as well as multicast and IPv6 routing in addition to the standard IPv4 routing functions. (IPv4 and IPv6 represent Internet Protocol versions 4 and 6, respectively, and are each fully familiar to those of ordinary skill in the art.) Since longest prefix matching is the technique common to all of these tasks, the same pipelined hardware can be used to perform them all efficiently, thereby producing significant savings in cost, complexity and space.

Despite the advantages of pipelined ASIC architectures, managing routing tries during route updates in such architectures is difficult. Although one way to simplify management would be to use double buffering—that is, to create a duplicate copy of the lookup trie and use one for lookups and the other for updates—the memory required would obviously be doubled, thereby doubling the relatively expensive SRAM cost. Therefore, it would be advantageous to provide for a pipelined ASIC-based architecture employing a (single) routing trie designed and generated in a manner which is highly amenable to efficient incremental updates.

### SUMMARY OF THE INVENTION

We have recognized that in order to provide for efficient incremental updates in a pipelined ASIC-based forwarding engine, it would be highly advantageous to design and generate the associated routing trie such that the memory allocated to the trie is evenly balanced across the multiple pipeline stages. In this manner, incremental updates to the trie are more likely to require memory modifications which are evenly distributed across the memory of the different pipeline stages, thereby taking advantage of the parallel processing capabilities inherent in such a pipelined architecture. Moreover, to the extent that memory allocated to the stages is not evenly balanced, the more heavily utilized stages are more likely to overflow given frequent insertions, thereby requiring that the entire trie be reconstructed. This can create a heavy update load that will cause significant disruption to packet forwarding operations.

Thus, in accordance with the principles of the present invention, a method and apparatus for generating a routing trie data structure for use in a pipelined forwarding engine such that portions of the data structure may be advantageously allocated among the memories associated with the various pipeline stages is provided. In accordance with one illustrative embodiment of the present invention, a dynamic programming technique is advantageously employed to build a trie which may be allocated to a plurality of pipeline stages such that the maximum amount of memory allocated to any of the stages is minimized (thereby ensuring that the memory is relatively balanced across all pipeline stages). The routing trie which is built in accordance with this illustrative embodiment of the present invention is advantageously a fixed-stride trie containing exactly one trie level stored in the memory of each pipeline stage.

### BRIEF DESCRIPTION OF THE DRAWINGS

FIG. 1 shows an illustrative routing table from which it may be desired to construct a routing trie.

FIG. 2 shows an illustrative routing trie representative of the illustrative routing table shown in FIG. 1.

FIG. 3 shows the result of performing leaf-pushing on the illustrative routing trie shown in FIG. 2.

FIG. 4 shows an illustrative pipelined forwarding engine, having n+1 stages, which may be employed in accordance with an illustrative embodiment of the present invention.

FIG. 5 shows an illustrative 1-bit trie representative of the illustrative routing table shown in FIG. 1.

FIG. 6 shows an illustrative 4-bit trie representative of the illustrative routing table shown in FIG. 1.

FIG. 7 shows an illustrative representation of a prior art technique for constructing a fixed-stride trie from a routing table with a minimum total memory requirement.

FIG. 8 shows an illustrative representation of a technique for constructing a fixed-stride trie from a routing table which minimizes the maximum amount of memory allocated to each stage of a pipelined forwarding engine in accordance with an illustrative embodiment of the present invention.

FIG. 9 shows a flow chart of an algorithm for constructing a fixed-stride trie from a routing table which minimizes the maximum amount of memory allocated to each pipeline stage in accordance with an illustrative embodiment of the present invention.

FIG. 10 shows a portion of an illustrative routing trie which may have been generated with use of one illustrative embodiment of the present invention.

FIG. 11 shows the portion of the illustrative routing tree of FIG. 10 after performing node pullup operations thereon in accordance with another illustrative embodiment of the present invention.

### DETAILED DESCRIPTION

Trie-Based IP Lookups in Forwarding Engines

As is well known to those skilled in the art, a trie is essentially a tree that is used to store routing prefixes for longest prefix matching. Each trie node contains two fields—an IP prefix represented by the node (null if none) and a pointer to an array of child nodes (null if none). The packet lookup process starts from the root and proceeds as follows. At each trie node, a specific number of consecutive bits (referred to as the “stride” of the node) from the destination IP address are used as an index to select which of the child nodes to traverse next. When a leaf node is reached, the last prefix seen along the path to the leaf is (by construction of the trie) the longest matching prefix for the packet.

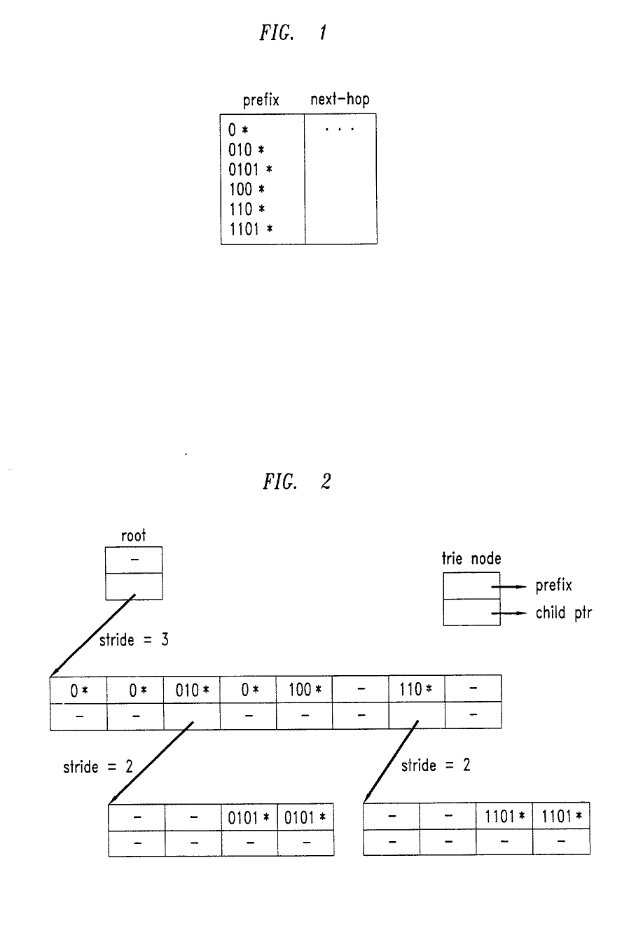

FIG. 1 shows an illustrative routing table from which it may be desired to construct a routing trie. FIG. 2 shows an illustrative routing trie representative of the illustrative routing table shown in FIG. 1. Each node in the illustrative trie of FIG. 2 has two fields—a prefix and a pointer to an array of child nodes. A dash (-) in the figure represents a null pointer. Note that in general, the stride at each trie node can be selected independently. A trie that uses the same stride for all the nodes in one level is referred to as a “fixed-stride” trie; otherwise, it is referred to as a “variable-stride” trie. The illustrative trie shown in FIG. 2 is a fixed-stride trie. In accordance with the illustrative embodiments of the present invention described in detail herein, fixed-stride tries are assumed. However, in accordance with other illustrative embodiments of the present invention, variable-stride trees may be generated instead.

An optimization referred to as “leaf-pushing,” familiar to those skilled in the art, can be advantageously employed to reduce a trie's memory requirement by half. Specifically, prefixes at non-leaf nodes are “pushed down” to all of the leaf nodes thereunder that do not already contain a more specific prefix. In this manner, each node advantageously contains only one field—either a prefix or a pointer to an array of child nodes, but not both. Thus each trie node can now fit into one word instead of two.

FIG. 3 shows the result of performing leaf-pushing on the illustrative routing trie shown in FIG. 2. In a leaf-pushed trie, such as the illustrative trie shown in FIG. 3, the longest matching prefix is always advantageously found in the leaf at the end of the traversed path. Nodes that contain a prefix pointer (that is, leaf nodes) may, for example, have a special bit set to indicate this fact, and may advantageously include a pointer to a separate table containing the corresponding next-hop information. Note, however, that updating a leaf-pushed trie is more expensive than updating a non-leaf-pushed trie, since a prefix may need to be added to (or deleted from) several leaf nodes where it needs to be (or has been) pushed down.

In accordance with the illustrative embodiments of the present invention described in detail herein, leaf-pushed tries are assumed. Moreover, in accordance with these illustrative embodiments, it is assumed that the next-hop information is stored in a separate table as described above. However, in accordance with other illustrative embodiments of the present invention, non-leaf-pushed trees may be generated as well, and other arrangements for storing the next-hop information (such as, for example, storing the next-hop information in the trie itself) may be used.

Pipelined Lookups Using Tries

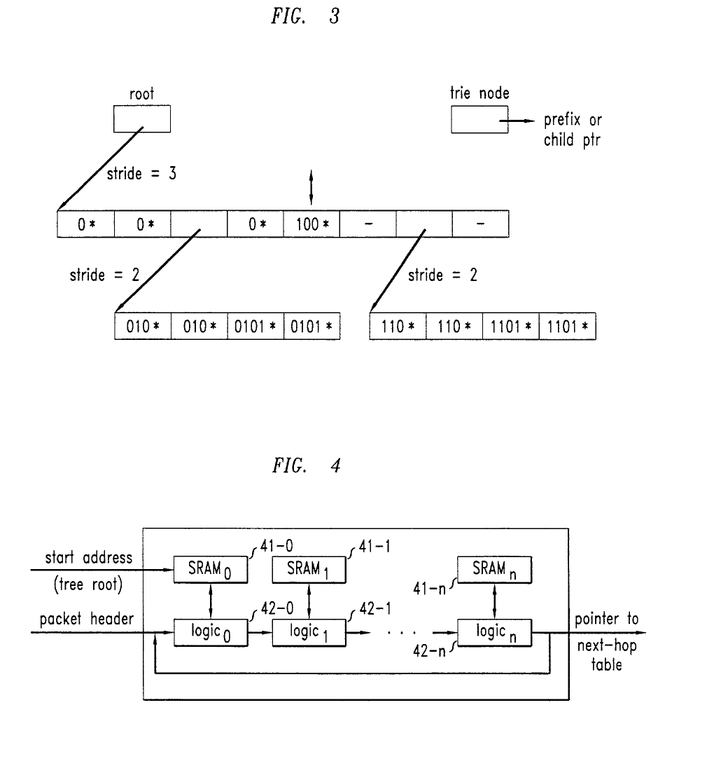

Tries are a natural candidate for pipelined lookups. FIG. 4 shows an illustrative pipelined forwarding engine, having n+1 stages, which may be employed in accordance with an illustrative embodiment of the present invention. In such a pipelined hardware architecture, each stage of the pipeline advantageously consists of its own fast memory such as, for example, SRAMs (shown in FIG. 4 as SRAMs 41-0 through 41-n) and some hardware circuitry (shown in FIG. 4 as logic circuits 42-0 through 42-n) to extract and shift the appropriate bits from a packet's destination address. These bits are then concatenated with the lookup result from the previous stage to form an index into the memory for the current stage. Thus, a different packet can be processed independently (and therefore simultaneously) in each stage of the pipeline. It can easily be seen that if each packet traverses the pipeline once, a forwarding result for one packet can be advantageously output each and every cycle. This can be advantageously achieved by storing each level of the trie in a different pipeline stage. In various illustrative embodiments of the present invention, pipelined architectures may include 4, 6, 8, or any other number of pipeline stages.

Note that during the forwarding operation, a packet may advantageously traverse the pipeline multiple times before the forwarding result is determined. The SRAMs in the pipeline typically have a latency of two or three cycles, although the searches (reads) can be pipelined. Note that by using leaf-pushing, the trie memory as well as the bandwidth required between the SRAM and the logic can be halved.

Since the pipeline is typically used for both forwarding and classification, its memories are advantageously shared by multiple tables (such as, for example, IPv4 and IPv6 routing tables, as well as packet filtering tables and multicast routing tables for each input interface). Therefore, evenly distributing the memory requirement of each table across the pipeline memories advantageously simplifies the task of memory allotment to the different tables. It also advantageously reduces the likelihood of any one memory stage overflowing due to route/filter additions.

An Illustrative Forwarding Engine

Updates to the forwarding table advantageously go through the same pipeline as the searches. Note that a single route update can cause several write messages to be sent through the pipeline. For example, the insertion of the route “1001*” to the illustrative trie shown in FIG. 3 will cause one write in the level 2 node (linking the new node to the trie), and four writes in the level 3 node (two writes for “1001*” and two writes for pushing down “100*”).

These software-controlled write messages may be advantageously packed into special write packets and sent down the pipeline, similar to the reads performed during a lookup. Each such write packet is referred to herein as a “bubble.” In particular, each bubble consists of a sequence of triples—each triple specifying a stage, a memory location, and a value—advantageously with at most one triple included for each stage. The pipeline logic at each stage advantageously issues the appropriate write command to its associated memory. As pointed out above, the more distributed the required write messages are amongst the various stages of the pipeline, the less disruption to the lookup process, since the write messages may be packaged into fewer such bubbles.

An illustrative line card on a core router in accordance with various illustrative embodiments of the present invention advantageously includes a forwarding engine that may, for example, be controlled by a local processor which may also be located on the line card. The local processor advantageously receives route updates from a central processor that processes BGP (Border Gateway Protocol) route update messages from neighboring routers, in a manner fully familiar to those of ordinary skill in the art. Using a software shadow of the pipelined routing trie, the local processor then advantageously computes the changes to be made to each stage of the forwarding pipeline for each route update. It may also advantageously perform all of the memory management for the pipeline memories.

A Prior Art Trie Construction Technique for Total Memory Minimization

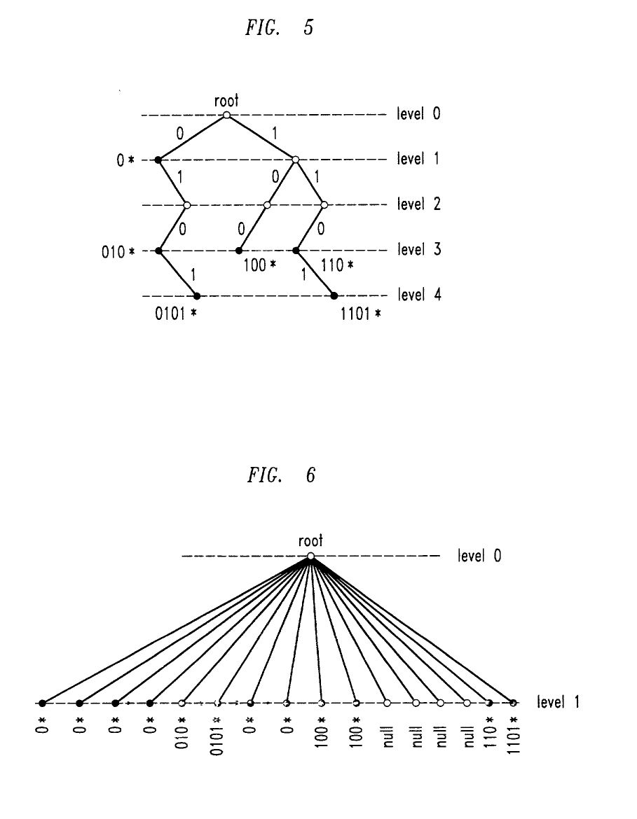

Routing tries used in forwarding engines present a natural trade-off between space (i.e., the memory requirement) and packet lookup time (i.e., the number of trie levels, assuming that one lookup operation per level is required). Large strides reduce the number of levels (and hence, the lookup time), but may cause a large amount of replication of prefixes. FIG. 5 shows an illustrative 1-bit trie representative of the illustrative routing table shown in FIG. 1. (The dotted lines in the figure show the nodes at each level in the trie. Only the shaded nodes contain a prefix.) This 1-bit trie (i.e., a trie where the stride size at each level is the minimum possible, namely, one bit) has 11 nodes, and each prefix occurs exactly once. However, the number of lookups in this trie can go up to four (e.g., for matching the prefix “0101*” or the prefix “1101*”).

On the other hand, FIG. 6 shows an illustrative 4-bit trie representative of the same illustrative routing table shown in FIG. 1. (Again, the dotted lines in the figure show the nodes at each level in the trie, and only the shaded nodes contain a prefix.) This alternative trie, with a stride size of 4, requires only one lookup, but has 17 nodes, since some of the prefixes (such as “0*”) are replicated while some of the nodes are empty.

To balance the space-time tradeoff in trie construction, one particular trie construction algorithm was proposed in V. Srinivasan and G. Varghese, “Fast Address Lookups Using Controlled Prefix Expansion,” ACM Transactions on Computer Systems, 17(1):1-40, February, 1999—hereinafter “Srinivasan and Varghese”. (Srinivasan and Varghese is hereby incorporated by reference as if fully set forth herein.) In particular, Srinivasan and Varghese use a technique known as controlled prefix expansion to construct memory-efficient tries for the set of prefixes in a given routing table. Given a maximum number of memory accesses allowed for looking up any IP address (i.e., the maximum number of trie levels), they use a dynamic programming technique to find the fixed-stride trie with the minimum total memory requirement.

As will be clear to one of ordinary skill in the art, the problem of constructing a fixed-stride trie fundamentally reduces to the problem of finding the stride-size at each level—that is, finding the bit positions at which to terminate each level. For example, the illustrative trie shown in FIG. 5 has its first level terminating at bit position 3, and its second level terminating at bit position 5. The dynamic programming technique used by Srinivasan and Varghese operates as follows:

First, a (hypothetical) 1-bit trie is constructed from all the prefixes (see, e.g., FIG. 5). Let nodes(i) be the number of nodes in the 1-bit trie at level i. Then, if a given trie level of a given multi-bit trie terminates at bit position i, and if the next trie level terminates at some bit position j>i, then each node in nodes(i+1) effectively gets expanded out to 2^{j-i} nodes in the multi-bit trie.

Now let T[j,r] be the optimal memory requirement (in terms of the number of trie nodes) for covering bit positions 0 through j using r trie levels (assuming that the leftmost bit position is 0). Then, as can be easily seen by one of ordinary skill in the art, T[j,r] can be computed using conventional dynamic programming techniques as follows:

$$\begin{matrix}T [ j , r ] = {min}_{m ∈ \{ r - 1 , K , j - 1 \}} ( T [ m , r - 1 ] + nodes ( m + 1 ) \times {2}^{j - m} ) \\ and & ( 1 ) \\ T [ j , 1 ] = {2}^{j + 1} & ( 2 )\end{matrix}$$

Note that they have chosen to terminate the (r−1)'th trie level at bit position m, so that it minimizes the total memory requirement. Thus, for prefixes with at most W bits, computing T[W−1,k], where k is the number of levels in the trie being constructed, provides the desired result. (Note that for IPv4, W=32, while for IPv6, W=128.)

FIG. 7 shows an illustrative representation of the above-described prior art technique for constructing a fixed-stride trie from a routing table with a minimum total memory requirement. More specifically, the figure shows geometrically the effect of Equation (1) above.

A Trie Construction Technique According to One Embodiment of the Invention

In accordance with an illustrative embodiment of the present invention, a novel algorithm, also based on controlled prefix expansion, generates a routing trie in a manner which is advantageously directed to providing an even allocation of memory across the different stages of a pipelined forwarding engine architecture. The illustrative algorithm assumes that each pipeline stage contains exactly one level of the routing trie, and advantageously satisfies the following constraints:

(1) each level in the fixed-stride trie to be generated fits into a single pipeline stage;

(2) the maximum memory allocated to a pipeline stage (over all stages) is minimized; and

(3) the total memory used is minimized subject to the first two constraints.

Note that the satisfaction of the second constraint above advantageously ensures that the memory allocation is reasonably balanced across all the pipelined stages. As a result of this constraint, the algorithm presented herein will be referred to as the “MinMax” algorithm (since it minimizes the maximum amount of memory allocated to a pipeline stage). Also, constraint (2) will be referred to as the “memory balance” constraint and constraint (3) will be referred to as the “memory minimization” constraint.

More formally, using a similar notation to that of Srinivasan and Varghese as provided above, let T[j,r] denote the total memory required for covering bit positions 0 through j using r trie levels, when the above conditions are satisfied. Furthermore, let P denote the size of the memory capacity of each pipeline stage. Then, the first and the third constraints are advantageously satisfied by the following equations:

$$\begin{matrix}T [ j , r ] = {min}_{m ∈ S} ( T [ m , r - 1 ] + nodes ( m + 1 ) \times {2}^{j - m} ) \\ and & ( 3 ) \\ T [ j , 1 ] = {2}^{j + 1} \\ where & ( 4 ) \\ S = \{ k \vert r - 1 \leq k \leq j - 1 and nodes ( k + 1 ) \times {2}^{j - k} \leq P \} & ( 5 )\end{matrix}$$

In order to ensure that the second constraint is satisfied, some additional notation will first be introduced. Let Space[j,r] denote the memory allocated to the r'th level in the multi-bit trie when bit positions 0 through j are covered by r levels in the trie. In other words:

Space[j,r]=nodes(m−1)×2^{j-m} (6)

where bit positions 0 through m are covered by r−1 levels in the trie. (Note that this necessarily implies that the r'th level in the trie covers bit positions m+1 through j). Then, define MaxSpace[j,r] as the maximum amount of memory allocated to any trie level, when bit positions 0 through j are covered by r levels in the trie. More formally:

$$MaxSpace [ j , r ] = {max}_{1 \leq k \leq r} Space [ {\sum }_{i = 1}^{k} {l}_{i} , k ] \qquad ( 7 )$$

where lᵢ denotes the stride-size of the i'th level in the trie, and

$${\sum }_{i = 1}^{r} {l}_{i} = j .$$

Then, in addition to Equations (3) and (4), the following equations are to be advantageously satisfied by the variable m:

$$\begin{matrix}MaxSpace [ j , r ] = {min}_{m ∈ S} ( max ( nodes ( m + 1 ) \times {2}^{j - m} , MaxSpace [ m , r - 1 ] ) ) \\ and & ( 8 ) \\ MaxSpace [ j , 1 ] = {2}^{j + 1} & ( 9 )\end{matrix}$$

Note that equation (8) is advantageously given precedence over equation (3) when choosing m, thereby ensuring that the memory balance constraint takes precedence over the memory minimization constraint. In particular, when multiple values of m yield the same value of MaxSpace[j,r], equation (3) is advantageously used to choose between these values of m. In other words, the “primary goal” of the illustrative algorithm is to reduce the maximum memory allocation across the pipeline stages (i.e., to satisfy the memory balance constraint), whereas the “secondary goal” is to minimize the total memory allocation (i.e., to satisfy the memory minimization constraint). Note that maintaining this secondary goal of overall memory efficiency as well as the primary goal of memory balance advantageously produces tries with low update overheads. (A “smaller”, memory-efficient trie typically has smaller strides and hence lesser replication of routes in the trie—a lower degree of route replication results in fewer trie nodes that need to be modified for a given route update.)

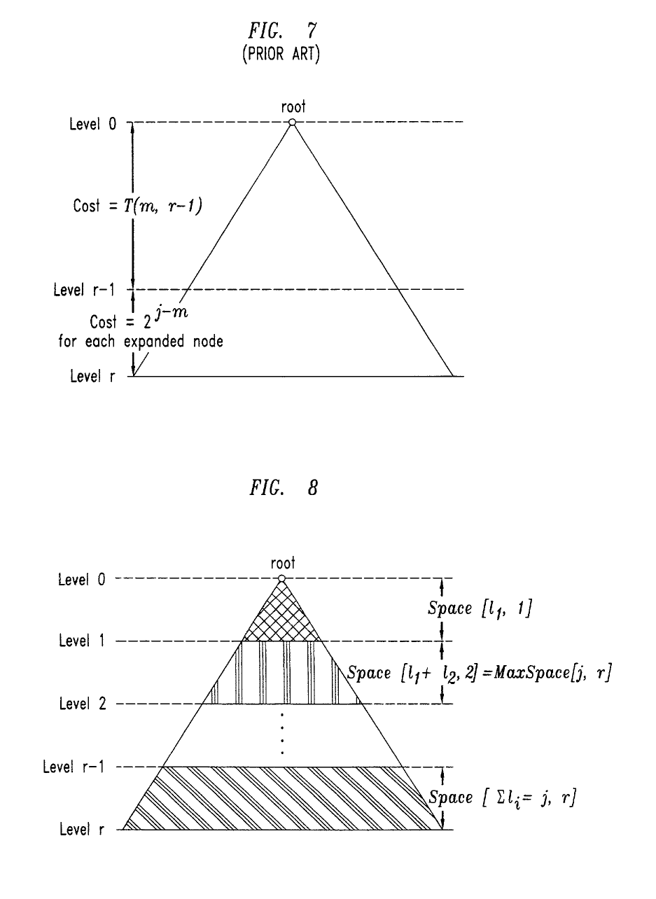

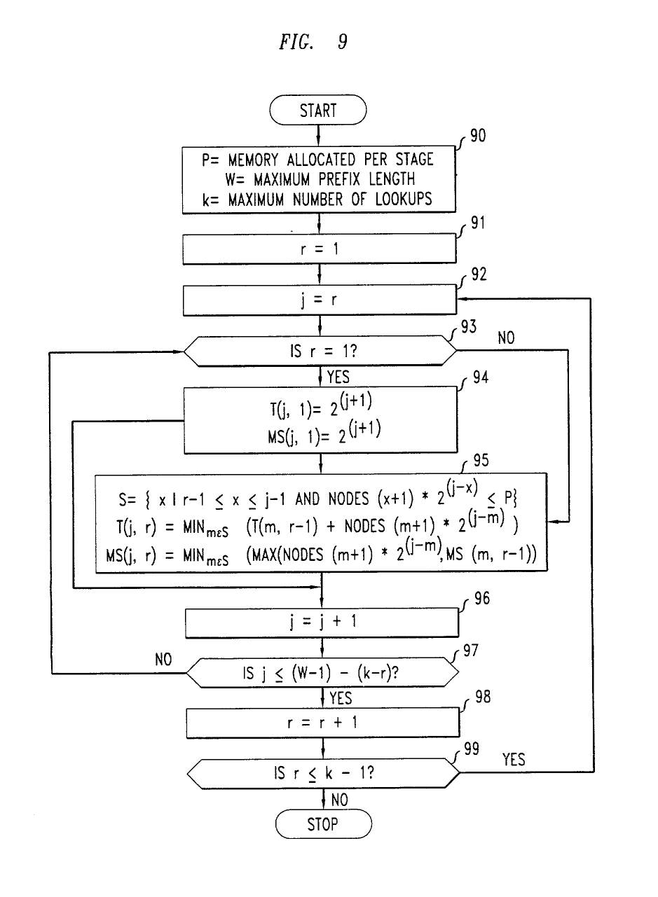

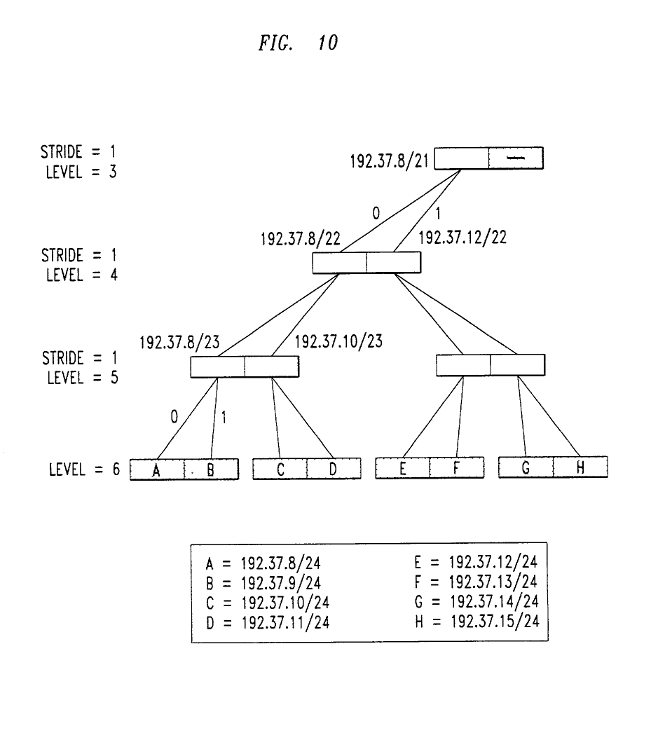

FIG. 8 shows an illustrative representation of the above-described technique for constructing a fixed-stride trie from a routing table which minimizes the maximum amount of memory allocated to each stage of a pipelined forwarding engine in accordance with an illustrative embodiment of the present invention. More specifically, the figure shows geometrically the effect of the above equations. In particular, and as shown in the figure, the second level illustratively occupies the most memory—that is, MaxSpace[j,r]=Space[l₁+l₂, 2].

FIG. 9 shows a flow chart of the above-described algorithm for constructing a fixed-stride trie from a routing table which minimizes the maximum amount of memory allocated to each pipeline stage in accordance with an illustrative embodiment of the present invention. Specifically, block 90 of FIG. 9 assigns the variables P, W, and k, as the memory capacity per stage, the maximum prefix length (e.g., 32 for IPv4), and the maximum number of lookups (i.e., the “depth” of the trie to be generated), respectively. Block 91 and block 92 initialize the variables r and j, respectively. Decision block 93 checks for the special handling required for the first iteration (i.e., r=1), and block 94 performs such special handling in accordance with Equations (4) and (9) above if it is in fact the first iteration. Otherwise, block 95 performs the functions of Equations (3), (5) and (8) above to determine both the total memory required for covering bit positions 0 through j using r trie levels, and the maximum memory allocated to any trie level when bit positions 0 through j are covered by r levels in the trie. Block 96 increments the value of j for the next iteration of the “inner loop,” and block 97 then tests the value of j to determine if the inner loop has been completed (i.e., if there are no more values of j that need to be considered for the given value of r). Similarly, block 98 increments the value of r for the next iteration of the “outer loop,” and block 99 then tests the value of r to determine if the procedure is completed (i.e., that the value of r has reached the value k—the maximum number of lookups, or, equivalently, the depth of the trie.

Note that in accordance with other illustrative embodiments of the present invention, rather than minimizing the maximum amount of memory allocated to a pipeline stage, minimizing some other metric may also be advantageously used in order to balance out the memory allocation across the multiple stages. Such other illustrative embodiments of the present invention include, for example, those that:

(1) minimize the standard deviation of all of the values of Space[j,r];

(2) minimize the sum of the squares of all the values of Space [j,r]; and

(3) minimize the difference between the maximum value of Space[j,r] and the minimum value of Space[j,r].

A Tree Optimizing Technique According to Another Embodiment of the Invention

Note that in fixed-stride tries, all 24-bit prefixes necessarily lie in a single level of the trie. It has been experimentally determined that in the case of IPv4, many, if not most, updates are made to 24-bit prefixes. Therefore, a large fraction of the pipeline writes are directed to that level, which resides in a single stage of the pipeline. Unfortunately, this “fact” makes it more difficult to efficiently pack the writes into bubbles. As such, and in accordance with another illustrative embodiment of the present invention, “node pullup” operations are advantageously performed on the trie constructed, for example, by the MinMax algorithm described above, in order to distribute the 24-bit prefix update load amongst various levels of the trie—that is, amongst various pipeline stages. (Although the illustrative embodiment of the present invention described in this section is directed in particular to the technique of node pullup operations as advantageously applied to 24-bit prefixes, it will be obvious that the same technique may be applied to prefixes of any other length, and may also be applied simultaneously to prefixes of more than one particular length.)

Specifically, node pullup operations are optimizations advantageously designed to spread out the 24-bit prefixes in the trie. Given that there are many groups of neighboring 24-bit prefixes in the trie (a “fact” which has also been experimentally determined), entire groups of such prefixes can be advantageously moved above the level that contains the 24-bit prefixes. For example, such a node pullup operation can be advantageously performed by increasing the stride of the node that is the lowest common ancestor of all the neighboring prefixes in the group. In particular, the MinMax algorithm as described above constructs a strictly fixed-stride trie—node pullup operations subsequently and advantageously modify the strides of some nodes in a controlled manner.

More specifically, let l be the level that contains the 24-bit prefixes. Consider a node in a level k above level l, and assume that k terminates at bit position n (where n<24). For some node in level k, if all of the 2²⁴⁻ⁿ possible 24-bit prefixes that can be descendants of this node are present in the trie, then, in accordance with an illustrative embodiment of the present invention, all of them may be advantageously pulled up into level k. Note that the stride of the parent of the pulled-up node is thereby increased by 24−n. In particular, this illustrative embodiment of the present invention examines nodes to pull up in a top-down manner, so that the 24-bit prefixes are advantageously pulled as far up as possible. Note also that the node pullup optimization, when performed in accordance with this illustrative embodiment of the present invention, advantageously ensures that the memory requirement of the transformed trie can be (possibly) reduced, but cannot be increased.

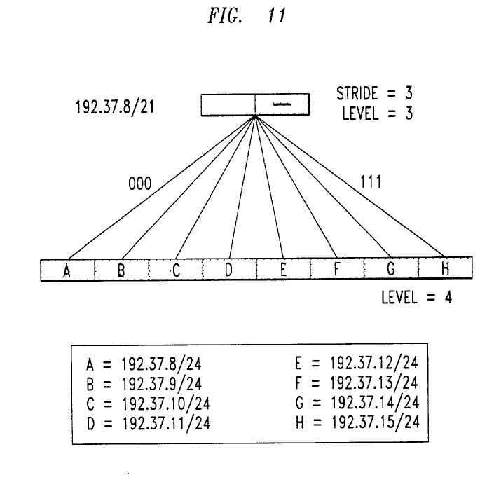

FIG. 10 shows a portion of an illustrative routing trie which may have been generated with use of one illustrative embodiment of the present invention, such as, for example, the MinMax algorithm. The nodes A, B, C, D, E, F, G and H represent 24-bit prefixes as shown in the table accompanying the trie in the figure. In accordance with another illustrative embodiment of the present invention, node pullup operations may be performed on the routing trie of FIG. 10.

Specifically, FIG. 11 shows the portion of the illustrative routing tree of FIG. 10 after performing node pullup operations thereon in accordance with another illustrative embodiment of the present invention. In particular, node pullup operations, as described above, have been advantageously performed on 24-bit prefix nodes A, B, C, D, E, F, G and H, each of which has been pulled up 2 levels. As can be seen from FIGS. 10 and 11, the total number of trie nodes (within the relevant trie portion) has advantageously decreased from 16 to 10.

Finally, in accordance with the above-described illustrative embodiment of the present invention, note that the pullup information (in the form of a changed stride length) may be stored in the node where the pullup has occurred. (Illustratively, 5 bits are sufficient to represent strides of up to 32 bits—these 5 bits can be easily fit into a single 32-bit word that may illustratively be used to represent a trie node. Assuming then that 1 bit is then used to flag leaf nodes, as many as 26 bits remain for addressing. Therefore, approximately 64 million locations can be addressed—much more than the typical size of a pipeline stage.) Therefore, if the node itself is deleted and then re-inserted (for example, due to a route withdrawal followed by a route insertion), this information may not be reconstructable. Instead, the only information available may be the trie level information that has been calculated by the illustrative MinMax algorithm.

In accordance with one illustrative embodiment of the present invention, therefore, in order to remedy this possible shortcoming, a state trie in software is advantageously employed when pullup operations are applied. The software state trie stores the pullup information at each node. When there is a deletion followed by an insertion, for example, the stride size of the inserted node may be advantageously obtained from the corresponding node in the software state trie. Of course, if a node that is not in the software state trie is inserted, the stride size may be advantageously obtained from the information given by, for example, the MinMax algorithm (as described above) which generated the original routing trie (before the node pullup operations were performed).

Addendum to the Detailed Description

It should be noted that all of the preceding discussion merely illustrates the general principles of the invention. It will be appreciated that those skilled in the art will be able to devise various other arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

The functions of the various elements shown in the figures, including functional blocks labeled as “processors” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

We claim:

1. A method for generating a routing trie data structure having a plurality of levels, the routing trie data structure for use in a data router forwarding engine having a pipelined architecture with a plurality of pipeline stages, each pipeline stage having a memory associated therewith and each of said levels of said routing trie data structure to be stored in a corresponding one of said memories, thereby resulting in a net quantity of memory usage in each of said associated pipeline stages, the method comprising the step of constructing said routing tree data structure and allocating the levels thereof to said corresponding memories by balancing said net quantities of memory usage among said pipeline stages, said balancing of said net quantities of memory usage comprising substantially minimizing a value of a function of said net quantities of memory usage in said pipeline stages.

2. The method of claim 1 wherein the value of said function of said net quantities of memory usage in said pipeline stages comprises a maximum value thereof.

3. The method of claim 1 wherein the value of said function of said net quantities of memory usage in said pipeline stages comprises a standard deviation computed over said net quantities of memory usage in said pipeline stages.

4. The method of claim 1 wherein the value of said function of said net quantities of memory usage in said pipeline stages comprises a sum of squares computed over said net quantities of memory usage in said pipeline stages.

5. The method of claim 1 wherein the value of said function of said net quantities of memory usage in said pipeline stages comprises a difference between a maximum value thereof and a minimum value thereof.

6. The method of claim 1 wherein said substantially minimizing said value of said function of said net quantities of memory usage in said pipeline stages is performed with use of a dynamic programming technique.

7. The method of claim 1 wherein the routing trie data structure comprises a fixed-stride, leaf-pushed routing trie.

8. The method of claim 1 wherein said routing trie data structure has n levels and said data router forwarding engine has a pipelined architecture with n pipeline stages, and wherein each of said n levels of said routing trie data structure is to be stored in a different one of said memories associated with said pipeline stages.

9. The method of claim 1 wherein said step of constructing said routing trie data structure and allocating the levels thereof to said corresponding memories substantially minimizes a sum of said net quantities of memory usage in said pipeline stages, subject to said value of said function of said net quantities of memory usage in said pipeline stages having been substantially minimized.

10. The method of claim 1 further comprising the step of modifying said constructed routing trie data structure and said allocation of the levels thereof to said corresponding memories, by performing one or more node pullup operations on said routing trie data structure and by re-allocating the levels of the modified routing trie data structure to said corresponding memories in accordance therewith.

11. The method of claim 10 further comprising the step of generating a software state trie comprising information relating to said one or more node pullup operations performed on said routing trie data structure.

12. An apparatus for generating a routing trie data structure having a plurality of levels, the routing trie data structure for use in a data router forwarding engine having a pipelined architecture with a plurality of pipeline stages, each pipeline stage having a memory associated therewith and each of said levels of said routing trie data structure to be stored in a corresponding one of said memories, thereby resulting in a net quantity of memory usage in each of said associated pipeline stages, the apparatus comprising at least one processor operative to construct said routing tree data structure and allocate the levels thereof to said corresponding memories by balancing said net quantities of memory usage among said pipeline stages, said balancing of said net quantities of memory usage comprising substantially minimizing a value of a function of said net quantities of memory usage in said pipeline stages.

13. The apparatus of claim 12 wherein the value of said function of said net quantities of memory usage in said pipeline stages comprises a maximum value thereof.

14. The apparatus of claim 12 wherein the value of said function of said net quantities of memory usage in said pipeline stages comprises a standard deviation computed over said net quantities of memory usage in said pipeline stages.

15. The apparatus of claim 12 wherein the value of said function of said net quantities of memory usage in said pipeline stages comprises a sum of squares computed over said net quantities of memory usage in said pipeline stages.

16. The apparatus of claim 12 wherein the value of said function of said net quantities of memory usage in said pipeline stages comprises a difference between a maximum value thereof and a minimum value thereof.

17. The apparatus of claim 12 wherein said substantially minimizing said value of said function of said net quantities of memory usage in said pipeline stages is performed with use of a dynamic programming technique.

18. The apparatus of claim 12 wherein the routing trie data structure comprises a fixed-stride, leaf-pushed routing trie.

19. The apparatus of claim 12 wherein said routing trie data structure has n levels and said data router forwarding engine has a pipelined architecture with n pipeline stages, and wherein each of said n levels of said routing trie data structure is to be stored in a different one of said memories associated with said pipeline stages.

20. The apparatus of claim 12 wherein said at least one processor operative to constructing said routing trie data structure and allocating the levels thereof to said corresponding memories substantially minimizes a sum of said net quantities of memory usage in said pipeline stages, subject to said value of said function of said net quantities of memory usage in said pipeline stages having been substantially minimized.

21. The apparatus of claim 12 wherein said at least one processor is further operative to modify said constructed routing trie data structure and said allocation of the levels thereof to said corresponding memories, by performing one or more node pullup operations on said routing trie data structure and by re-allocating the levels of the modified routing trie data structure to said corresponding memories in accordance therewith.

22. The apparatus of claim 21 wherein said at least one processor is further operative to generate a software state trie comprising information relating to said one or more node pullup operations performed on said routing trie data structure.

23. A computer-readable media comprising executable program code for generating a routing trie data structure having a plurality of levels, the routing trie data structure for use in a data router forwarding engine having a pipelined architecture with a plurality of pipeline stages, each pipeline stage having a memory associated therewith and each of said levels of said routing trie data structure to be stored in a corresponding one of said memories, thereby resulting in a net quantity of memory usage in each of said associated pipeline stages, the executable program code comprising code for constructing said routing tree data structure and allocating the levels thereof to said corresponding memories by balancing said net quantities of memory usage among said pipeline stages, said balancing of said net quantities of memory usage comprising substantially minimizing a value of a function of said net quantities of memory usage in said pipeline stages.

24. The computer-readable media of claim 23 wherein the value of said function of said net quantities of memory usage in said pipeline stages comprises a maximum value thereof.

25. The computer-readable media of claim 23 wherein said routing trie data structure has n levels and said data router forwarding engine has a pipelined architecture with n pipeline stages, and wherein each of said n levels of said routing trie data structure is to be stored in a different one of said memories associated with said pipeline stages.

26. A data router forwarding engine having a pipelined architecture comprising a plurality of pipeline stages, each pipeline stage having a memory associated therewith, a routing trie data structure having a plurality of levels having been stored in said memories such that each of said levels of said routing trie data structure has been stored in a corresponding one of said memories, thereby resulting in a net quantity of memory usage in each of said associated pipeline stages, the routing tree data structure having been constructed and the levels thereof having been allocated to said corresponding memories by balancing said net quantities of memory usage among said pipeline stages, said balancing of said net quantities of memory usage having comprised substantially minimizing a value of a function of said net quantities of memory usage in said pipeline stages.

27. The data router forwarding engine of claim 26 wherein the value of said function of said net quantities of memory usage in said pipeline stages comprises a maximum value thereof.

28. The data router forwarding engine of claim 26 wherein said routing trie data structure has n levels and said data router forwarding engine has a pipelined architecture with n pipeline stages, and wherein each of said n levels of said routing trie data structure is to be stored in a different one of said memories associated with said pipeline stages.
